(19) United States
(12) Patent Application Publication
(10) Pub. No.: US 2005/0154589 A1
(43) Pub. Date: Jul. 14, 2005

(54) Acoustic model creating method, acoustic model creating apparatus, acoustic model creating program, and speech recognition apparatus

(75) Inventors: Masanobu Nishitani, Suwa-shi (JP); Yasunaga Miyazawa, Okaya-shi (JP); Hiroshi Matsumoto, Nagano-shi (JP); Kazumasa Yamamoto, Nagano-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/990,626

(22) Filed: Nov. 18, 2004

(30) Foreign Application Priority Data
Nov. 20, 2003 (JP) 2003-390681

(51) Int. Cl. G10L 15/00

(52) U.S. Cl. 704/256

(57) ABSTRACT

Exemplary embodiments of the present invention enhance the recognition ability by optimizing state numbers of respective HMM's. Exemplary embodiments provide a description length computing unit to find description lengths of respective syllable HMM's for which the number of states forming syllable HMM's is set to plural kinds of state numbers from a given value to the maximum state number, using the Minimum Description Length criterion, for each of syllable HMM's set to their respective state numbers. An HMM selecting unit selects an HMM having the state number with which the description length found by the description length computing device is a minimum. An HMM re-training unit re-trains the syllable HMM selected by the syllable HMM selecting unit with the use of training speech data.

### BACKGROUND OF THE INVENTION

1. Field of Invention

Exemplary embodiments of the present invention relate to an acoustic model creating method, an acoustic model creating apparatus, and an acoustic model creating program for creating Continuous Mixture Density HMM's (Hidden Markov Models) as acoustic models, and to a speech recognition apparatus.

2. Description of Related Art

The related art includes speech recognition which adopts a method by which phoneme HMM's or syllable HMM's are used as acoustic models, and a speech, in units of words, clauses, or sentences, is recognized by connecting the phoneme HMM's or syllable HMM's. Continuous Mixture Density HMM's, in particular, can be used extensively as acoustic models having higher recognition ability.

When HMM's are created in units of these phonemes and syllables, HMM's are created by setting the state numbers of all HMM's empirically to a specific constant (for example, “3” for phonemes and “5” for syllables).

When HMM's are created by setting the state numbers to a specific constant as described above, the structure of phoneme or syllable HMM's becomes simpler, which in turn makes it relatively easy to create HMM's. The recognition rate, however, may be reduced in some HMM's because their ability is not optimized accurately.

In order to address and/or solve such a problem, the structure of HMM's has been optimized in related art document JP-A-6-202687.

According to the technique of related art document JP-A-6-202687, for each state of HMM's, the state is divided repetitively in either the time direction or the context direction, whichever is the direction for the likelihood to be a maximum, in order to optimize the structure of HMM's by dividing minutely.

Another example of optimizing the structure of HMM's uses the Minimum Description Length (MDL) criterion as disclosed in related art document. Takatoshi JITSUHIRO, Tomoko MATSUI, and Satoshi NAKAMURA of ATR Spoken Language Translation Research Laboratories, “MDL-kijyun o motiita tikuji jyoutai bunkatu-hou niyoru onkyou moderu jidou kouzou kettei”, the IEICE Technical Report, SP2002-127, December 2002, pp. 37-42.

The technique of related art document Takatoshi JITSUHIRO, Tomoko MATSUI, and Satoshi NAKAMURA of ATR Spoken Language Translation Research Laboratories, “MDL-kijyun o motiita tikuji jyoutai bunkatu-hou niyoru onkyou moderu jidou kouzou kettei”, the IEICE Technical Report, SP2002-127, December 2002, pp. 37-42 is to determine, with the use of the MDL criterion, which of the time axis direction or the context direction is the dividing direction in which to divide the state by the technique of related art document JP-A-6-202687 described above, and the MDL criterion is calculated for each state of HMM's.

According to the MDL criterion, when a model set {1, . . . , i, . . . , I} and data χ^{N}={χ₁, . . . , χ_{N}} are given, the description length li(χ^{N}) using a model i is defined as Equation (1):

$${l}_{i} ( {x}^{N} ) = - log {P}_{\hat{θ} ( i )} ( {x}^{N} ) + \frac{{β}_{i}}{2} log N + log I . \qquad ( 1 )$$

According to the MDL criterion, a model whose description length li(χ^{N}) is a minimum is assumed to be an optimum model.

### SUMMARY OF THE INVENTION

According to the technique of related art document JP-A-6-202687, it is indeed possible to obtain HMM's that are optimized to some extent, and the recognition rate is thereby expected to increase. The structure of HMM's, however, becomes complicated in comparison with the related art Left-to-Right HMM's.

Hence, not only the recognition algorithm becomes more complicated, but also a time needed for recognition is extended. A volume of calculation and a quantity of memory are thus increased, which poses a problem that it is difficult to apply this technique to a device whose hardware resource is strictly limited, in particular, a device for which lower prices are required.

The same or similar problems are addressed with regard to the technique of related art JP-A-6-202687. Also, because the technique of related art Takatoshi JITSUHIRO, Tomoko MATSUI, and Satoshi NAKAMURA of ATR Spoken Language Translation Research Laboratories, “MDL-kijyun o motiita tikuji jyoutai bunkatu-hou niyoru onkyou moderu jidou kouzou kettei”, the IEICE Technical Report, SP2002-127, December 2002, pp. 37-42 is to find the MDL criterion for each state of HMM's, there is another problem that a volume of calculation needed to optimize HMM's is increased.

It is therefore an object of exemplary embodiments of the invention to provide an acoustic model creating method, an acoustic model creating apparatus, and an acoustic model creating program capable of increasing the recognition rate with a less volume of calculation and a less quantity of memory, by enabling HMM's to be optimized without complicating the structure of HMM's. Exemplary embodiments provide a speech recognition apparatus that, by using such acoustic models, becomes applicable to an inexpensive system whose hardware resource, such as a computing power and a memory capacity, is strictly limited.

(1) An acoustic model creating method of exemplary embodiments of the invention is an acoustic model creating method of optimizing state numbers of HMM's and re-training HMM's having the optimized state numbers with the use of training speech data. The acoustic model creating method includes: a step of setting the state numbers of HMM's to plural kinds of state numbers from a given value to a maximum state number, and finding a description length of each of HMM's that are set to have the plural kinds of state numbers, with the use of a Minimum Description Length criterion; selecting an HMM having the state number with which the description length is a minimum; and re-training the selected HMM with the use of training speech data.

It is thus possible to set optimum state numbers for respective HMM's, and the recognition ability can be thereby enhanced or improved. In particular, a noticeable characteristic of HMM's of exemplary embodiments of the invention is that they are Left-to-Right HMM's of a simple structure, which can in turn simplify the recognition algorithm. Also, HMM's of the invention, being HMM's of a simple structure, contribute to the lower prices and the lower power consumption, and general recognition software can be readily used. Hence, they can be applied to a wide range of recognition apparatus, and thereby provide excellent compatibility.

(2) In the acoustic model creating method according to (1), according to the Minimum Description Length criterion, when a model set {1, . . . , i, . . . , I} and data χ^{N}={χ₁, . . . , χ_{N}} (where N is a data length) are given, a description length li(χ^{N}) using a model i is expressed by a general equation defined as Equation (1) above, and in the general equation to find the description length, let the model set {1, . . . , i, . . . , I} be a set of HMM's when the state number of an HMM is set to plural kinds from a given value to a maximum state number, then, given I kinds (I is an integer satisfying I≧2) as the number of the kinds of states, 1, . . . , i, . . . , I are codes to specify respective kinds from a first kind to an I'th kind, and Equation (1) above is used as an equation to find a description length of an HMM having an i'th state number among 1, . . . , i, . . . , I.

Hence, when the state number of a given HMM is set to various state numbers from a given value to the maximum state number, description lengths of HMM's set to have their respective state numbers, can be readily calculated. By selecting an HMM having the state number with which the description length is a minimum on the basis of the calculation result, it is possible to set an optimum state number for this HMM.

(3) In the acoustic model creating method according to (2), it is preferable to use Equation (2)

$${l}_{i} ( {x}^{N} ) = - log {P}_{\hat{θ} ( i )} ( {x}^{N} ) + α ( \frac{{β}_{i}}{2} log N ) \vert$$

which is re-written from Equation (1) above, as an equation to find the description length.

Equation (2) above is an equation re-written from the general equation to find the description length defined as Equation (1) above, by multiplying the second term on the right side by a weighting coefficient α, and omitting the third term on the right side that stands for a constant. By omitting the third term on the right side that stands for a constant in this manner, the calculation to find the description length can be simpler.

(4) In the acoustic model creating method according to (3), α in Equation (2) above is a weighting coefficient to obtain an optimum state number.

By making the weighting coefficient α used to obtain the optimum state number variable, it is possible to make a slope of a monotonous increase in the second term variable (the slope is increased as α is made larger), which can in turn make the description length li(χ^{N}) variable. Hence, by setting α to be larger, it is possible to adjust the description length li(χ^{N}) to be a minimum when the state number is smaller.

(5) In the acoustic model creating method according to (3) or (4), β in Equation (2) above is expressed by: distribution number×dimension number of feature vector×state number.

By defining β in Equation (2) above as: distribution number×dimension number of feature vector×state number, it is possible to obtain the description lengths that exactly reflect the features of respective HMM's
(6) In the acoustic model creating method according to any of (2) through (5), the data χ^{N} is a set of respective training speech data obtained by matching, for each state in time series, HMM's having an arbitrary state number among the given value through the maximum state number to a large number of training speech data.

The description lengths can be found with accuracy by calculating the description lengths using, as the data χ^{N} in Equation (1) above, the training speech data obtained by using respective HMM's having an arbitrary state number, and by matching each HMM to a large number of training speech data corresponding to the HMM in time series
(7) In the acoustic model creating method according to any of (1) through (6), the HMM's are preferably syllable HMM's.

In the case of exemplary embodiments of the invention, by using syllable HMM's, advantages, such as a reduction in volume of computation, can be achieved. For example, when the number of syllables are 124, syllables outnumber phonemes (about 26 to 40). In the case of phoneme HMM's, however, a triphone model is often used as an acoustic model unit. Because the triphone model is constructed as a single phoneme by taking preceding and subsequent phoneme environments of a given phoneme into account, when all the combinations are considered, the number of models will reach several thousands. Hence, in terms of the number of acoustic models, the number of the syllable models is far smaller.

Incidentally, in the case of syllable HMM's, the number of states forming respective syllable HMM's is about five in average for syllables including a consonant and about three in average for syllables including a vowel alone, thereby making a total number of states of about 600. In the case of a triphone model, however, a total number of states can reach several thousands even when the number of states is reduced by state tying among models.

Hence, by using syllable HMM's as HMM's, it is possible to reduce a volume of general computation, including, as a matter of course, the calculation to find the description lengths. It is also possible to address and/or achieve the recognition accuracy comparable to that of triphone models. It goes without saying that exemplary embodiments of the invention are applicable to phoneme HMM's.

(8) In the acoustic model creating method according to (7), for plural syllable HMM's having a same consonant or a same vowel among the syllable HMM's, of states forming the syllable HMM's, initial states or plural states including the initial states in syllable HMM's are tied for syllable HMM's having the same consonant, and final states among states having self loops or plural states including the final states in syllable HMM's are tied for syllable HMM's having the same vowels.

The number of parameters can be thus reduced further, which enables a volume of computation and a quantity of used memories to be reduced further and the processing speed to be increased further. Moreover, the advantages of addressing and/or achieving the lower prices and the lower power consumption can be greater.

(9) An acoustic model creating apparatus of exemplary embodiments of the invention are an acoustic model creating apparatuses that optimize state numbers of HMM's and re-train HMM's having the optimized state numbers with the use of training speech data. The acoustic model creating apparatus includes a description length calculating device to find a description length of each of HMM's when the state number of an HMM is set to plural kinds of state numbers from a given value to a maximum state number, with the use of a Minimum Description Length criterion; an HMM selecting device to select an HMM having the state number with which the description length found by the description length calculating device is a minimum; and an HMM re-training device to re-train the HMM selected by the HMM selecting device with the use of training speech data.

With the acoustic model creating apparatus, the same or similar advantages as the acoustic model creating method according to (1) can be addressed and/or achieved.

(10) An acoustic model creating program of exemplary embodiments of the invention are an acoustic model creating programs to optimize state numbers of HMM's and re-train HMM's having the optimized state numbers with the use of training speech data. The acoustic model creating program includes finding a description length of each of HMM's when the state number of an HMM is set to plural kinds of state numbers from a given value to a maximum state number, with the use of a Minimum Description Length criterion; selecting an HMM having the state number with which the description length is a minimum; and re-training the selected HMM with the use of training speech data.

With the acoustic model creating program, the same or similar advantages as the acoustic model creating method according to (1) can be addressed and/or achieved.

In the acoustic model creating method according to (9) and the acoustic model creating program according to (10) as well, according to the Minimum Description Length criterion, when a model set {1, . . . , i, . . . , I} and data χ^{N}={χ₁, . . . , X_{N}} (where N is a data length) are given, a description length li(χ^{N}) using a model i is expressed by a general equation defined as Equation (1) above. In the general equation to find the description length, let the model set {1, . . . , i, . . . , I} be a set of HMM's when the state number of an HMM is set to plural kinds from a given value to a maximum state number, then, given I kinds (I is an integer satisfying I≧2) as the number of the kinds of states, 1, . . . , i, . . . , I are codes to specify respective kinds from a first kind to an I'th kind, and Equation (1) above is used as an equation to find a description length of an HMM having an i'th state number among 1, . . . , i, . . . , I.

It is preferable to use Equation (2) above, which is re-written from modified Equation (1) above, as an equation to find the description length.

Herein, α in Equation (2) above is a weighting coefficient to obtain an optimum state number. Also, β in Equation (2) above is expressed by: distribution number×dimension number of feature vector×state number.

Also, the data χ^{N} is a set of respective training speech data obtained by matching, for each state in time series, HMM's having an arbitrary state number among the given value through the maximum state number to a large number of training speech data.

Further, the HMM's are preferably syllable HMM's. In addition, for plural syllable HMM's having a same consonant or a same vowel among the syllable HMM's, of states forming the syllable HMM's, initial states or plural states including the initial states in syllable HMM's can be tied for syllable HMM's having the same consonant, and final states among states having self loops or plural states including the final states in syllable HMM's can be tied for syllable HMM's having the same vowels.

(11) A speech recognition apparatus of exemplary embodiments of the invention is a speech recognition apparatus to recognize an input speech, using HMM's as acoustic models with respect to feature data obtained through feature analysis on the input speech, which is characterized in that HMM's created by the acoustic model creating method according to any of (1) through (8) are used as the HMM's used as the acoustic models.

As has been described, the speech recognition apparatus of exemplary embodiments of the invention uses acoustic models (HMM's) created by the acoustic model creating method of exemplary embodiments of the invention as described above. When HMM's are syllable HMM's, because respective syllable HMM's have optimum state numbers, the number of parameters in respective syllable HMM's can be reduced markedly in comparison with HMM's all having a constant state number, and the recognition ability can be thereby enhanced and/or improved. Also, because these syllable HMM's are Left-to-Right syllable HMM's of a simple structure, the recognition algorithm can be simpler, too, which can in turn reduce a volume of computation and a quantity of used memories. Hence, the processing speed can be increased and the prices and the power consumption can be lowered.

It is thus possible to provide a speech recognition apparatus particularly useful for a compact, inexpensive system whose hardware resource is strictly limited.

### BRIEF DESCRIPTION OF THE DRAWINGS

FIG. 1 is a schematic view detailing an acoustic model creating procedure in a first exemplary embodiment of the invention;

FIG. 2 is a schematic view to describe a manner in which syllable HMM sets are created when the state number is set to seven kinds from 3 to the maximum state number (state number 9);

FIG. 3 is a schematic view of a unit extracted from FIG. 1, which is needed to describe alignment data creating processing in acoustic model creating processing shown in FIG. 1;

FIGS. 4A-C are schematic views to describe a concrete example of processing to match respective syllable HMM's to training speech data 1 in creating alignment data 5;

FIG. 5 is a schematic view of a unit extracted from FIG. 1, which is needed to describe processing to find description lengths of respective HMM's having the state number 3 through the maximum state number (the state number 9) in the acoustic model creating processing shown in FIG. 1;

FIG. 6 is a schematic view showing a manner in which description lengths of respective syllable HMM's having the state number 3 through the maximum state number (the state number 9) are found for syllable HMM's of a syllable /a/;

FIG. 7 is a schematic view of a unit extracted from FIG. 1, which is needed to describe a manner in which a syllable HMM is selected according to the MDL criterion in the acoustic model creating processing shown in FIG. 1;

FIG. 8 is a schematic view to describe processing to select a syllable HMM of a minimum description length for respective syllable HMM's having the state number 3 through the maximum state number (the state number 9) according to the MDL criterion;

FIGS. 9A-B are schematic views to explain a weighting coefficient α used in the first exemplary embodiment;

FIGS. 10A-B are schematic views to describe a concrete example of start frames and end frames in respective syllables obtained by the alignment data creating processing described in the first exemplary embodiment;

FIGS. 11A-B are schematic views to describe processing to calculate likelihoods corresponding to respective syllables when respective syllable HMM's having a given state number are used, using the start frames and the end frames obtained in FIG. 10;

FIG. 12 is a schematic view showing the calculation result of likelihoods corresponding to respective syllables, using respective syllable HMM's having the state numbers from the state number 3 to the state number 9;

FIG. 13 is a schematic view showing a result when a total frame numbers and a total likelihood are found for respective syllables in each of the state numbers from the state number 3 to the state number 9;

FIG. 14 is a view to schematically describe the configuration of a speech recognition apparatus of the invention;

FIG. 15 is a schematic view to describe state tying in a second exemplary embodiment of the invention, describing a case where initial states or final states (the final states among the states having self loops) are tied in some of syllable HMM's;

FIG. 16 is a schematic view showing two connected syllable HMM's that tie the initial states, with the matching to given speech data; and

FIG. 17 is a schematic view to describe an example of the state tying shown in FIG. 15 where plural states including the initial states or plural states including the final states are tied.

### DETAILED DESCRIPTION OF PREFERRED EMBODIMENTS

Exemplary embodiments of the invention will now be described. The contents described in these exemplary embodiments include all the descriptions of an acoustic model creating method, an acoustic model creating apparatus, an acoustic model creating program, and a speech recognition apparatus of exemplary embodiments of the invention. Also, exemplary embodiments of the invention are applicable to both phoneme HMM's and syllable HMM's, but the exemplary embodiments below will describe syllable HMM's.

### First Exemplary Embodiment

A first exemplary embodiment will describe an example case where the state numbers of syllable HMM's corresponding to respective syllables (herein, 124 syllables) are to be optimized.

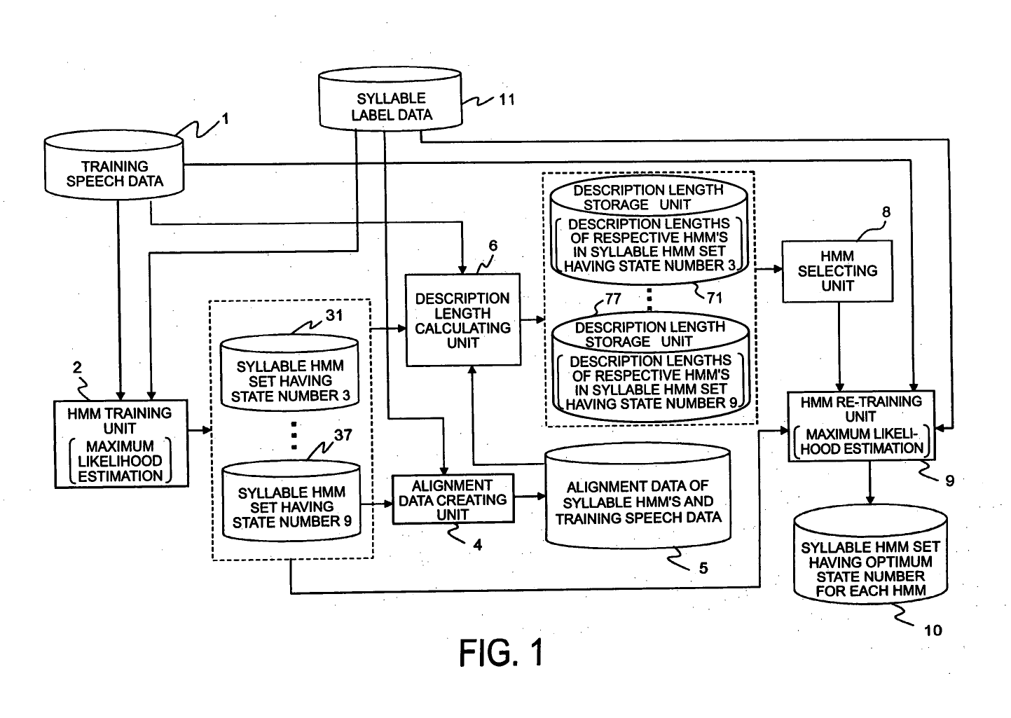

The flow of overall processing in the first exemplary embodiment will be described briefly with reference to FIG. 1 through FIG. 8.

Initially, syllable HMM sets are formed, in which the number of states (states having self loops) that together form individual syllable HMM's corresponding to 124 syllables (the state number) is set from a given value to the maximum state number. In this instance, the distribution number in each state can be an arbitrary value; however, 64 is given as the distribution number in the first exemplary embodiment. Also, the lower limit value of the state number (the minimum state number) is 1 and the upper limit value (the maximum state number) is an arbitrary value; however, seven kinds of state numbers, including the state number 3, the state number 4, . . . , and the state number 9, are set in the first exemplary embodiment.

To be more specific, in this case, seven kinds of syllable HMM sets 31, 32, . . . , and 37 having the seven kinds of state numbers, 3, 4, . . . , and 9, respectively, are created for each syllable HMM as follows: a syllable HMM set including all syllable HMM's having the distribution number 64 and the state number 3, a syllable HMM set 31 including all syllable HMM's having the distribution number 64 and the state number 4, a syllable HMM set 32 including all syllable HMM's having the distribution number 64 and the state number 4 (not shown in FIG. 1) and so on. While this exemplary embodiment will be described on the assumption that there are seven kinds of state numbers, it should be appreciated that the state numbers are not limited to seven kinds. For example, the minimum state number is not limited to 3, and the maximum state number is not limited to 9.

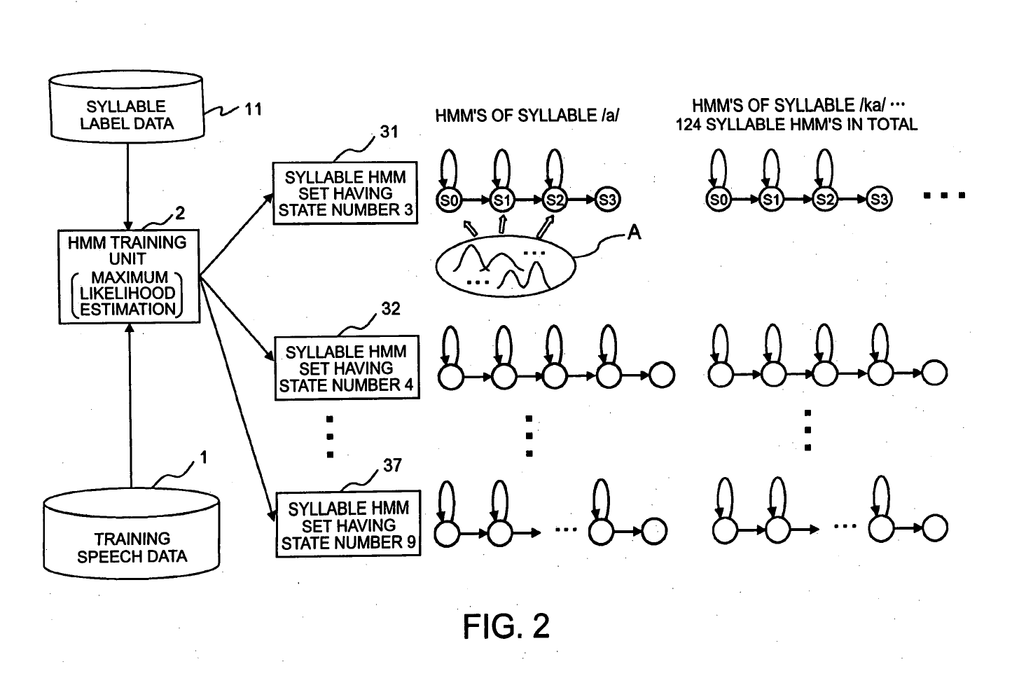

For all the syllable HMM's belonging to the seven kinds of syllable HMM sets, an HMM training unit 2 trains parameters of respective syllable HMM's by the maximum likelihood estimation method, and thereby creates trained syllable HMM's having the state number 3 through the maximum state number (in this case, the state number 9). In other words, in this exemplary embodiment, because there are seven kinds of state numbers, including the state number 3, the state number 4, . . . , and the state number 9, seven kinds of trained syllable HMM sets 31 through 37 are created correspondingly. This will be described with reference to FIG. 2.

The HMM training unit 2 trains individual syllable HMM sets having seven kinds of state numbers, 3, 4, . . . , and 9, respectively, for respective syllables (124 syllables, including a syllable /a/, a syllable /ka/, and so on) by the maximum likelihood estimation method, using training speech data 1 and syllable label data 11 (in the syllable label data are written syllable sequences that form respective training speech data), and creates the syllable HMM sets 31, 32, . . . , and 37 having their respective state numbers.

Hence, in each of the syllable HMM sets 31, 32, . . . , and 37 having the state number 3, the state number 4, . . . , and the state number 9, respectively, are present syllable HMM's that have been trained in respective 124 syllables in a manner as follows. In the syllable HMM set 31 having the state number 3 are present syllable HMM's that have been trained in respective 124 syllables, such as a syllable HMM of a syllable /a/, a syllable HMM of a syllable /ka/, and so on. Likewise, in the syllable HMM set 32 having the state number 4 are present syllable HMM's that have been trained in respective 124 syllables, such as a syllable HMM of a syllable /a/, a syllable HMM of a syllable /ka/, and so on.

Referring to FIG. 2, the Gaussian distribution, within an elliptic frame A shown below the respective states S0, S1, and S2 in a syllable HMM of a syllable /a/ in the syllable HMM set 31 for which 3 is given as the number of states having self loops (state number 3), indicates an example of the distribution numbers in respective states. As has been described, in this exemplary embodiment, because 64 is given as the distribution number for respective states in all the syllable HMM's, the respective states S0, S1, and S2 have the same distribution number.

Referring to FIG. 2, the distribution numbers are shown only for the respective states S0, S1, and S2 in the syllable HMM of a syllable /a/ in the syllable HMM set 31 having the state number 3 and the distribution number is omitted from the drawing for the other syllable HMM's. It should be noted, however, that each syllable HMM has the distribution number 64.

In this manner, the syllable HMM sets 31 through 37 respectively corresponding to the seven kinds of state numbers, that is, the syllable HMM set 31 having the state number 3, the syllable HMM set 32 having the state number 4, . . . , and the syllable HMM set having the maximum state number (in this case, the syllable HMM sets 37 having the state number 9), are created by the training in the HMM training unit 2.

Referring to FIG. 1 again, of the syllable HMM set 31 having the state number 3, the syllable HMM set 32 having the state number 4 (not shown in FIG. 1), . . . , and the syllable HMM set 37 having the state number 9 that have been trained by the training in the HMM training unit 2, an arbitrary syllable HMM set (preferably, the one with accuracy as high as possible) is selected as an alignment data creating syllable HMM set.

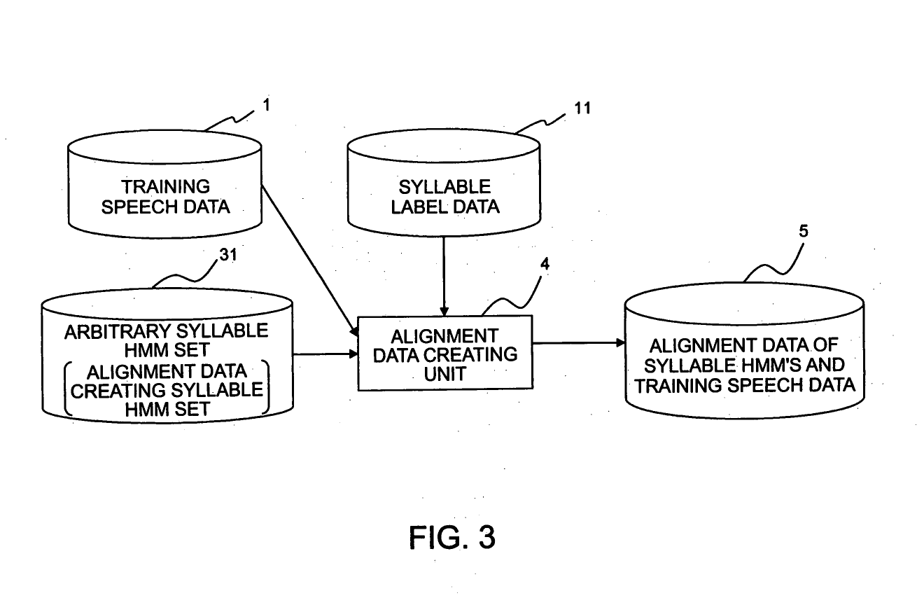

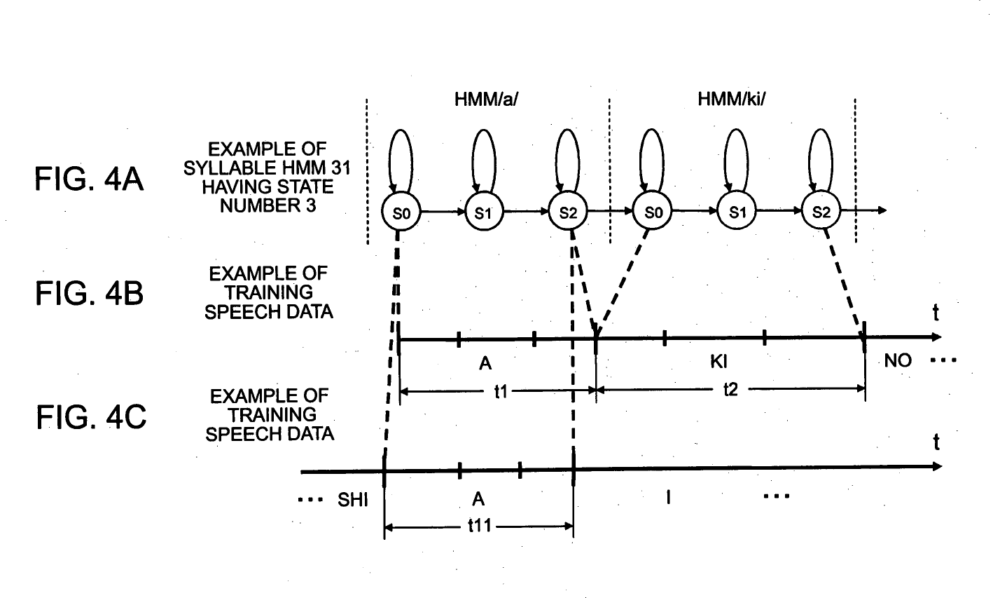

An alignment data creating unit 4 then takes Viterbi alignment, using all the syllable HMM's (respective syllable HMM's corresponding to 124 syllables) belonging to the alignment data creating syllable HMM set, the training speech data 1, and the syllable label data 11, and creates alignment data 5 of the respective syllable HMM's in the alignment data creating syllable HMM set and the training speech data 1. This will be described with reference to FIG. 3 and FIG. 4.

FIG. 3 shows a unit extracted from FIG. 1, which is needed to describe the alignment data creating processing. FIGS. 4A-C describe a concrete example when the respective syllable HMM's belonging to the alignment data creating syllable HMM set are matched to the training speech data 1 in order to create the alignment data 5.

As has been described, the alignment data creating syllable HMM set is preferably a syllable HMM set with accuracy as high as possible. FIG. 3 and FIG. 4, however, show an example case where, of the syllable HMM set 31 having the state number 3 through the syllable HMM set 37 having the state number 9, the syllable HMM set 31 having the state number 3 is selected for ease of explanation.

The alignment data creating unit 4 takes alignment of the respective syllable HMM's in the syllable HMM set 31 having the state number 3 and the training speech data 1 corresponding to their respective syllables as are shown in FIG. 4A, FIG. 4B, and FIG. 4C, using all the training speech data 1, the syllable label data 11, and the syllable HMM set 31 having the state number 3.

For example, as is shown in FIG. 4B, when the alignment is taken for an example of training speech data, “AKINO (autumn). . . ”, matching is performed on the training speech data, “A”, “KI”, “NO”, . . . , in such a manner that a syllable HMM of a syllable /a/ having the state number 3 matches to an interval t1 of the training speech data, a syllable HMM of a syllable /ki/ matches to an interval t2 of the training speech data and so on. The matching data thus obtained is used as the alignment data 5. In this instance, the start frame number and the end frame number of a data interval are obtained for each matching data interval as a piece of the alignment data 5.

Also, as is shown in FIG. 4C, matching is performed on training speech data, “ . . . SHIAI (game). . . ”, as one example of training speech data, in such a manner that a syllable HMM of a syllable /a/ having the state number 3 matches to an interval t11 of the training speech data and so on. The matching data thus obtained is used as the alignment data 5. As with the foregoing example, the start frame number and the end frame number of a data interval are obtained for each matching data interval as a piece of the alignment data 5.

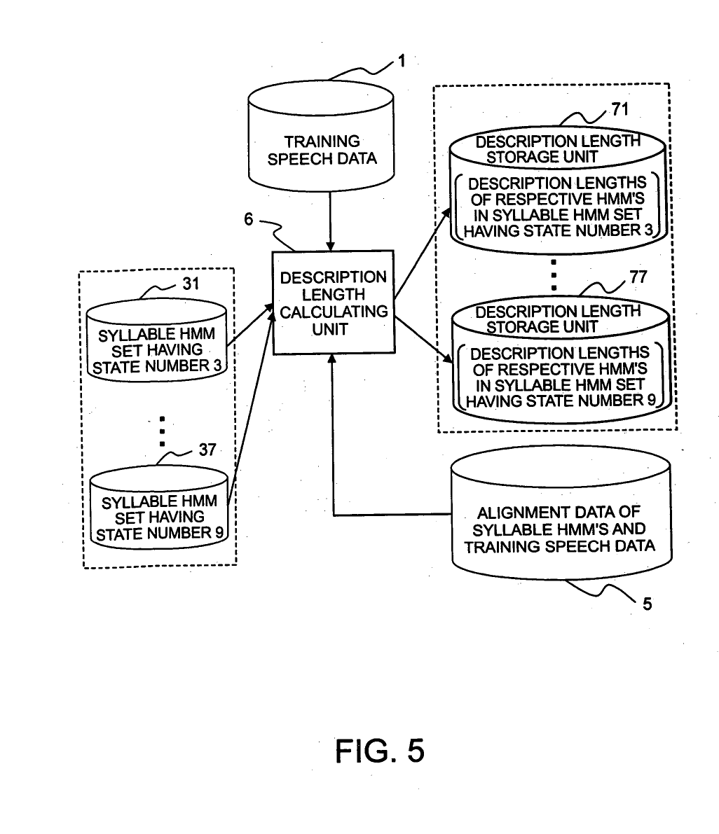

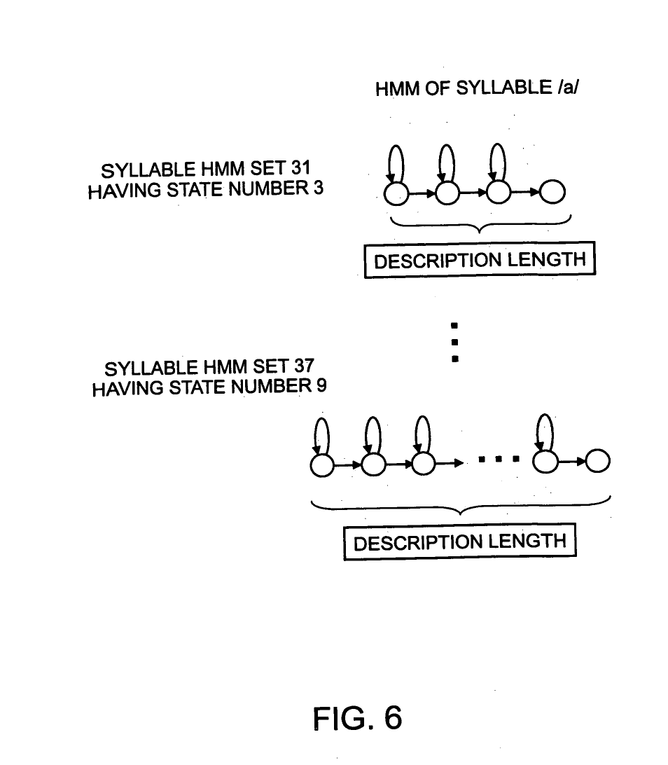

A description length calculating unit 6 shown in FIG. 1 then finds the description lengths of all the syllable HMM's, for syllable HMM sets having a given state number to the maximum state number (in this case, the syllable HMM sets 31 through 37 respectively corresponding to the seven kinds of state numbers, including the state number 3, the state number 4, . . . , and the state number 9), using the alignment data 5 of the respective syllable HMM's in the syllable HMM set having the state number 3 and the training speech data, found in the alignment data creating unit 4. This will be described with reference to FIG. 5 and FIG. 6.

FIG. 5 is a unit extracted from FIG. 1, which is needed to describe the description length calculating unit 6. Parameters of the syllable HMM sets 31 through 37 having the state number 3 through the state number 9, respectively, the training speech data 1, and the alignment data 5 of the respective syllable HMM's and the training speech data 1 are provided to the description length calculating unit 6.

The description length calculating unit 6 then calculates independently the description lengths of respective syllable HMM's belonging to the syllable HMM set having the state number 3, the description lengths of respective syllable HMM's belonging to the syllable HMM set having the state number 4, . . . , and the description lengths of respective syllable HMM's belonging to the syllable HMM set having the state number 9.

To be more specific, the description lengths, including those from the description lengths of respective syllable HMM's in the syllable HMM set 31 having the state number 3 to the description lengths of respective syllable HMM's having the state number 9, are obtained in such a manner that the description lengths of respective syllable HMM's in the syllable HMM set 31 having the state number 3 are obtained, the description lengths of respective syllable HMM's in the syllable HMM set 32 having the state number 4 are obtained, and so on. The description lengths, including those from the description lengths of respective syllable HMM's in the syllable HMM set 31 having the state number 3 to the description lengths of respective syllable HMM's having the state number 9, are held in description length storage units 71 through 77 in a one-to-one correspondence with the syllable HMM sets, namely the syllable HMM set 31 having the state number 3 through the syllable HMM set 37 having the state number 9. The manner in which the description lengths are calculated will be described below.

FIG. 6 shows a case, for example, when the description lengths of respective HMM's of a syllable /a/ are found from the description lengths of respective syllable HMM's belonging to the syllable HMM set 31 having the state number 3 (the description lengths of respective syllable HMM's held in the description length storage unit 71) through the description lengths of respective syllable HMM's belonging to the syllable HMM set 37 having the state number 9 (the description lengths of respective syllable HMM's held in the description length storage unit 77), found in FIG. 5.

As can be understood from FIG. 6, the description lengths of respective syllable HMM's of a syllable /a/ corresponding to the seven kinds of state numbers from the state number 3 to the state number 9 are found in such manner that the description length of a syllable HMM of a syllable /a/ having the state number 3 is found, the description length of a syllable HMM of a syllable /a/ having the state number 4 (not shown) is found, and so on. Of the seven kinds of distribution numbers, FIG. 6 shows only syllable HMM's of a syllable /a/ having the state number 3 and the state number 9.

However, the description lengths of respective syllable HMM's corresponding to the seven kinds of state numbers from the state number 3 to the state number 9 are found for other syllables in the same manner.

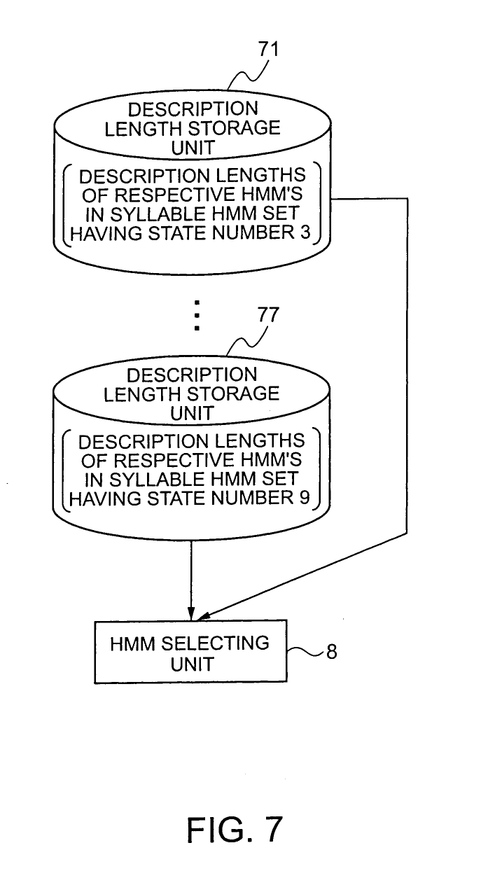

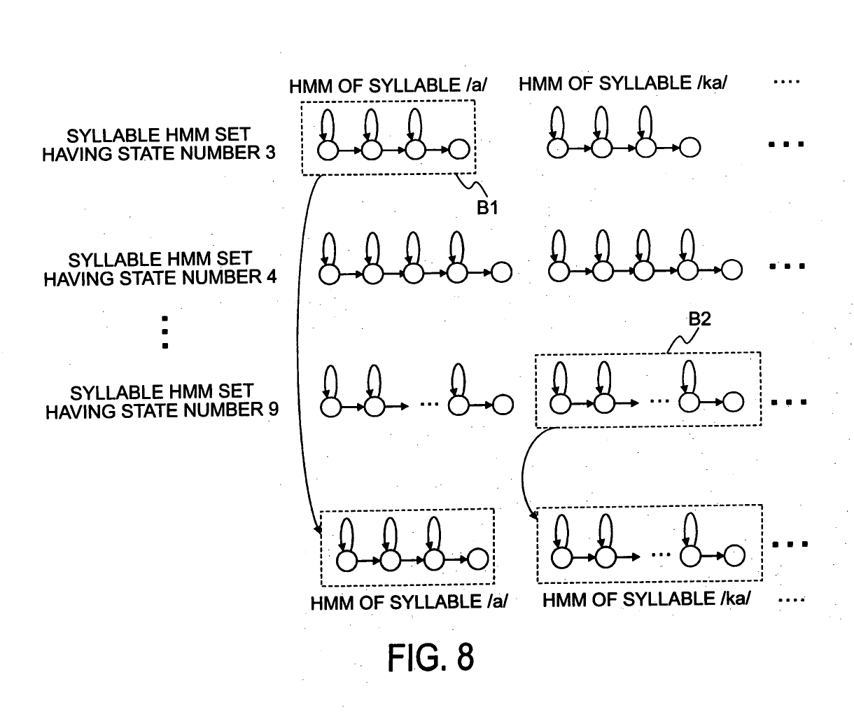

An HMM selecting unit 8 then selects a syllable HMM having the state number with which the description length is a minimum among those found for respective syllable HMM's, for each syllable HMM in all the syllable HMM's, using the description lengths, including those from the description lengths found for the syllable HMM set 31 having the state number 3 to the description lengths found for the syllable HMM set 37 having the state number 9, calculated in the description calculating unit 6. This will be described with reference to FIG. 7 and FIG. 8.

FIG. 7 is a unit extracted from FIG. 1, which is needed to describe the HMM selecting unit 8. The HMM selecting unit 8 selects a syllable HMM having the state number with which the description length is a minimum, by judging with what state number the description length of a syllable HMM will be a minimum, for each syllable HMM in reference to the description lengths, including those from the description lengths of the syllable HMM set 31 having the state number 3 (description lengths of respective states held in the description length storage unit 71) to the description lengths of the syllable HMM set 37 having the state number 9 (description lengths of respective states held in the description length storage unit 77), calculated in the description length calculating unit 6.

Herein, syllable HMM's having the state numbers with which the description lengths are minimums are selected for a syllable HMM of a syllable /a/ and a syllable HMM of a syllable /ka/, by judging with what state number the description of a syllable HMM will be a minimum (of the minimum description length), for each of syllable HMM's of a syllable /a/ and syllable HMM's of a syllable /ka/ that correspond to the seven kinds of state numbers from the state number 3 to the state number 9. This selection processing will be described with reference to FIG. 8.

Initially, assume that a syllable HMM of a syllable /a/ having the state number 3 is judged to be of the minimum description length, from the judging result on syllable HMM's of a syllable /a/ as to with what state number from the state number 3 to the state number 9 the description length of a syllable HMM of a syllable /a/ will be a minimum. This is indicated by a broken line B1.

As to syllable HMM's of a syllable /a/, by judging with what state number the description length of an HMM will be a minimum, for each of syllable HMM's having the state number 3 through the state number 9 in the manner described above, a syllable HMM of a syllable /a/ having the state number 3 is judged to be of the minimum description length.

Likewise, assume that an HMM having the state number 9 is judged to be of the minimum description length, from the judging result on syllable HMM's of a syllable /ka/ as to with what state number from the state number 3 to the state number 9 the description length of an HMM will be a minimum. This is indicated by a broken line B2.

Such processing is performed for all syllable HMM's to judge with what state number from state number 3 to the state number 9 the description length of an HMM will be a minimum, for each syllable HMM, and a syllable HMM having the state number with which the description length is a minimum is selected for each syllable HMM.

All those syllable HMM's having the state numbers with which the description lengths are minimums, selected as has been described, can be said as syllable HMM's having the optimum state numbers among respective syllable HMM's.

An HMM re-training unit 9 obtains respective syllable HMM's having the optimum state numbers selected by the HMM selecting unit 8 from the syllable HMM set 31 having the state number 3, . . . , and the syllable HMM set 37 having the state number 9, and re-trains all the parameters of these syllable HMM's having the optimum state numbers by the maximum likelihood estimation method, using the training speech data 1 and the syllable label data 11. It is thus possible to obtain a syllable HMM set (a syllable HMM set including syllable HMM's respectively corresponding to 124 syllables) 10 having the optimized state numbers and updated to optimum parameters.

The MDL (Minimum Description Length) criterion used in exemplary embodiments of the invention will now be described. The MDL criterion is disclosed in related art document HAN Te-Sun, Iwanami Kouza Ouyou Suugaku 11, Jyouhou to Fugouka no Suuri, IWAMAMI SHOTEN (1994), pp. 249-275. As described in the background art column, when a model set {1, . . . , i, . . . , I} and data χ^{N}={χ₁, . . . , X_{N}} (where N is a data length) are given, the description length li(χ^{N}) using a model i is defined as Equation (1) above, and according to the MDL criterion, a model whose description length li(χ^{N}) is a minimum is assumed to be an optimum model.

In exemplary embodiments of the invention, a model set {1, . . . , i, . . . , I} is thought to be a set of HMM's for a given HMM whose state number is set to plural kinds from a given value to the maximum state number. Let I kinds (I is an integer satisfying I≧2) be the kinds of state numbers when the state number is set to plural kinds from a given value to the maximum state number, then 1, . . . , i, . . . , I are codes to specify the respective kinds from the first kind to the I'th kind. Hence, Equation (1) above is used as an equation to find the description length of an HMM having the state number of the i'th kind among 1, . . . , i, . . . , I.

I in 1, . . . , i, . . . , I stands for a sum of HMM sets having different state numbers, that is, it indicates how many kinds of state numbers are present. In this exemplary embodiment, I=7 because the state numbers are of seven kinds, including 3, 4, . . . , 9.

Because 1, . . . , i, . . . , I are codes to specify any kind from the first kind to the I'th kind as has been described, in a case of this exemplary embodiment, of 1, . . . , i, . . . , I, 1 is given to the state number 3 as a code indicating the kind of the state number, thereby specifying that the kind of the state number is the first kind. Also, of 1, . . . , i, . . . , I, 2 is given to the state number 4 as a code indicating the kind of the state number, thereby specifying that the kind of the state number is the second kind. Further, of 1, . . . , i, . . . , I, 3 is given to the state number 5 as a code indicating the kind of the state number, thereby specifying that the kind of the state number is the third kind. Furthermore, of 1, . . . , i, . . . , I, 7 is given to the state number 9 as a code indicating the kind of the state number, thereby specifying that the kind of the state number is the seventh kind. In this manner, codes, such as 1, 2, 3, . . . , 7, to specify the kinds of state numbers are given to the state numbers 3, 4, . . . , 9, respectively.

When consideration is given to syllable HMM's of a syllable /a/, as is shown in FIG. 8, a set of syllable HMM's having seven kinds of state numbers from the state number 3 to the state number 9 form one model set.

Hence, in exemplary embodiments of the invention, the description length li(χ^{N}) defined as Equation (1) above is defined as Equation (2) above on the assumption that it is the description length li(χ^{N}) of a syllable HMM when the kind of a given state number is set to the i'th kind among 1, . . . , i, . . . , I.

Equation (2) above is different from Equation (1) above in that log I in the third term, which is the final term on the right side of Equation (1) above, is omitted because it is a constant, and that (βi/2)log N, which is the second term on the right side of Equation (1) above, is multiplied by a weighting coefficient α. In Equation (2) above, log I in the third term, which is the final term on the right side of Equation (1) above, is omitted, however, it may not be omitted and left intact.

Also, β is a dimension (the number of free parameters) of an HMM having the i'th state number as the kind of the state number, and can be expressed by: distribution number×dimension number of feature vector×state number. Herein, the dimension number of the feature vector is: cepstrum (CEP) dimension number+delta cepstrum (CEP) dimension number+delta power (POW) dimension number.

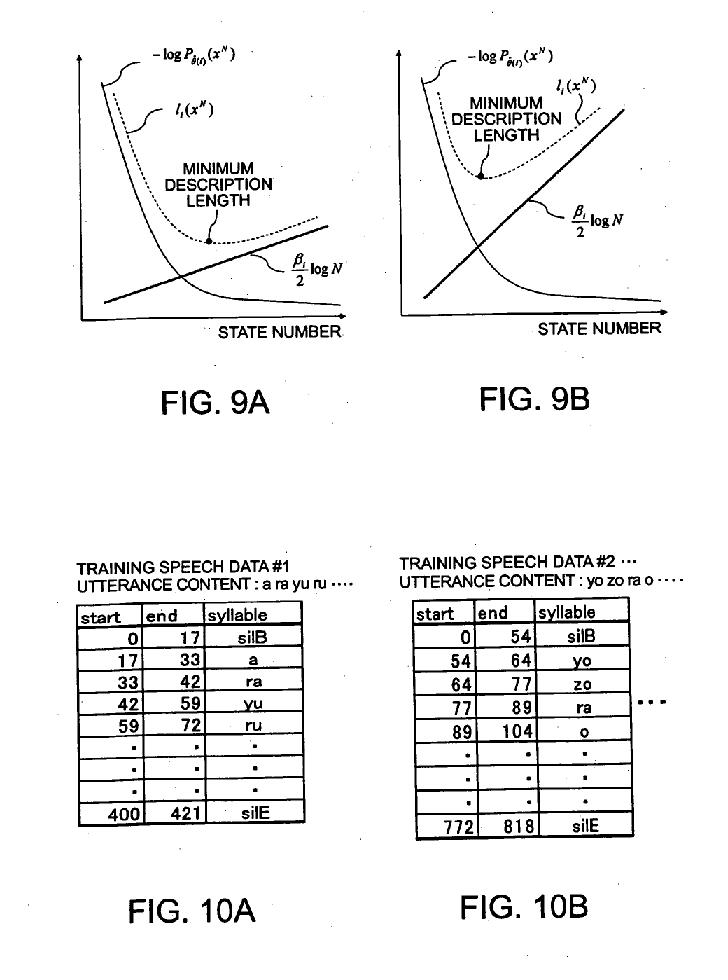

Also, α is a weighting coefficient to adjust the state number to be optimum, and the description length li(χ^{N}) can be changed by changing α. That is to say, as are shown in FIGS. 9A and 9B, in very simple terms, the value of the first term on the right side of Equation (2) above decreases as the state number increases (indicated by a fine solid line), and the second term on the right side of Equation (2) above increases monotonously as the state number increases (indicated by a thick solid line). The description length li(χ^{N}), found by a sum of the first term and the second term, therefore takes values indicated by a broken line.

Hence, by making α variable, it is possible to make a slope of the monotonous increase of the second term variable (the slope becomes larger as α is made larger). The description length li(χ^{N}), found by a sum of the first term and the second term on the right side of Equation (2) above, can be thus changed by changing the value of α. Hence, FIG. 9A is changed to FIG. 9B by, for example, making α larger, and it is therefore possible to adjust the description length li(χ^{N}) to be a minimum when the state number is smaller.

An HMM having the i'th state number in Equation (2) above corresponds to M pieces of data (M pieces of data including a given number of frames). That is to say, let n1 be the length (the number of frames) of data 1, n2 be the length (the number of frames) of data 2, and nM be the length (the number of frames) of data M, then N Of χ^{N} is expressed as: N=n1+n2+ . . . +nM. Thus, the first term on the right side of Equation (2) above is expressed by Equation (3) set forth below.

Data 1, data 2, . . . , and data M referred to herein mean data corresponding to a given interval in which a large number of training speech data 1 matched to HMM's having the state i are present (for example, as has been described with reference to FIG. 4, training speech data matched to the interval t1 or the interval t11).

Formula 1
log P_{\hat{θ}(i)}(x^{N})=logP_{\hat{θ}(i)}(xⁿ^{ᵢ})+logP_{\hat{θ}(i)}(xⁿ^{₂})+ . . . +logP_{\hat{θ}(i)}(xⁿ^{_{M}}) (3)

In Equation (3) above, respective terms on the right side are likelihoods of the matched training speech data intervals when syllable HMM having the i'th state number are matched to respective training speech data. As can be understood from Equation (3) above, the likelihood of a given syllable HMM having the i'th state number is expressed by a sum of likelihoods of respective training speech data matched to this syllable HMM.

Incidentally, in the description length li(χ^{N}) found by Equation (2) above, assume that, a model whose description length li(χ^{N}) is a minimum is the optimum model, that is, for a given syllable HMM, a syllable HMM having the state number with which the description length li(χ^{N}) is a minimum is in the optimum state.

To be more specific, in this exemplary embodiment, because the state numbers are of seven kinds, including 3, 4, . . . , 9, seven kinds of description lengths are obtained as the description length li(χ^{N}) for a given HMM as follows: a description length 11(χ^{N}) of states when the state number 3 (first kind of the state number) is given; a description length 12(χ^{N}) of states when the state number 4 (second kind of the state number) is given; a description length 13(χ^{N}) of states when the state number 5 (third kind of the state number) is given; a description length 14(χ^{N}) of states when the state number 6 (fourth kind of the state number) is given; a description length 15(χ^{N}) of states when the state number 7 (fifth kind of the state number) is given; a description length 16(χ^{N}) of states when the state number 8 (sixth of the state number) is given; and a description length 17(χ^{N}) of states when the state number 9 (seventh of the state number) is given. From these, a syllable HMM having the state number with which the description length is a minimum is selected.

For example, in the case of FIG. 8, when consideration is given to syllable HMM's of a syllable /a/, the description lengths of syllable HMM's having the state number 3 through the state number 9 are found from Equation (2) above, and a syllable HMM having the minimum description length is selected. Then, in FIG. 8, as has been described, a syllable HMM having the state number 3 is selected on the ground that a syllable HMM having the state number 3 is of the minimum description length.

When consideration is given to syllable HMM's of a syllable /ka/, the description lengths of states having the state number 3 through the state number 9 are found from Equation (2) above, and a syllable HMM having the minimum description length is selected in the same manner. Then, in FIG. 8, as has been described, a syllable HMM having the state number 9 is selected on the ground that a syllable HMM having the state number 9 is of the minimum description length.

As has been described, the description length li(χ^{N}) of each syllable HMM is calculated for respective syllable HMM's having the state number 3 through the state number 9 from Equation (2) above. A syllable HMM of the minimum description length is selected by judging with what state number the description length of a syllable HMM will be a minimum, for respective syllable HMM's. Then, all the parameters of syllable HMM's having the state numbers with which the description lengths are minimums are re-trained for each syllable HMM, by the maximum likelihood estimation method using the training speech data 1 and the syllable label data 11.

It is thus possible to obtain syllable HMM's respectively corresponding to 124 syllables, which have optimized state numbers and optimum parameters for each state. Syllable HMM's respectively corresponding to 124 syllables are created as the syllable HMM set 10 (see FIG. 1). Because the state numbers are optimized for the respective syllable HMM's belonging to the syllable HMM set 10, satisfactory recognition ability can be ensured. Moreover, in comparison with a case where all the syllable HMM's have the same state number, the number of parameters is expected to decrease, and not only can a volume of computation and a quantity of used memories be reduced, but also the processing speed can be increased. Further, the prices and the power consumption can be lowered.

An experiment conducted by the inventor of the invention will now be described by way of example.

FIGS. 10A-B show frame numbers of start frames and frame numbers of end frames of data intervals matched to respective syllables obtained when a syllable HMM set having a given state number, selected as alignment data creating syllable HMM's as described with reference to FIG. 4, is matched to the training speech data (herein, the number of training speech data is about 20,000) (the syllable label data 11 is also used).

FIG. 10A shows frame numbers of start frames (start) and end frames (end) of data intervals corresponding to respective matched syllables /a/, /ra/, /yu/, /ru/, . . . , when a syllable HMM of /a/, a syllable HMM of /ra/, a syllable HMM of /yu/, and a syllable HMM of /ru/ in a syllable HMM set having a given state number are matched to speech training data, such as “a ra yu ru (all). . . ”(which is referred to as training speech data #1).

Referring to the drawing, the start frame number of the data interval matched to a syllable /a/ is 17, and the end frame number is 33. The start frame number of the data interval matched to a syllable /ra/ is 33, and the end frame number is 42. Also, the start frame number of the data interval matched to a syllable /yu/ is 42, and the end frame number is 59. The start frame number of the data interval matched to a syllable /ru/ is 59, and the end frame number is 72. Referring to FIG. 10, “silb” indicates a silent interval at the beginning of utterance, and “silE” indicates a silent interval at the end of utterance.

Likewise, FIG. 10B shows frame numbers of start frames (start) and end frames (end) of data intervals corresponding to respective syllables /yo/, /zo/, /ra/, and /o/, when a syllable HMM of /yo/, a syllable HMM of /zo/, a syllable HMM of /ra/, and a syllable HMM of /o/ are matched to speech training data, such as “yo zo ra o (night sky). . . ” (which is referred to as training speech data #2).

Referring to the drawing, the start frame number of the data interval matched to a syllable /yo/ is 54, and the end frame number is 64. The start frame number of the data interval matched to a syllable /zo/ is 64, and the end frame number is 77. Also, the start frame number of the data interval matched to a syllable /ra/ is 77, and the end frame number is 89. The start frame number of the data interval matched to a syllable /o/ is 89, and the end frame number is 104.

Matching as described above is performed on all the training speech data. The likelihood can be found when the alignment data is calculated; however, it is sufficient in this instance to obtain information as to the start frame numbers and the end frame numbers.

The description length calculating unit 6 initially calculates likelihood frame by frame (from the start frame to the end frame) in each syllable HMM for respective syllable HMM's belonging to the syllable HMM sets 31 through 37 having their respective state numbers (herein, the state number 3 through state number 9), using the start frame numbers and the end frame numbers of data intervals matched to respective syllables obtained from the matching of the respective syllable HMM's (all syllable HMM's belonging to the alignment data creating syllable HMM set) to training speech data as are shown in FIG. 10. In other words, the likelihood is calculated frame by frame (from the start frame to the end frame) matched to all the training speech data for respective syllable HMM's having the state number 3 through state number 9.

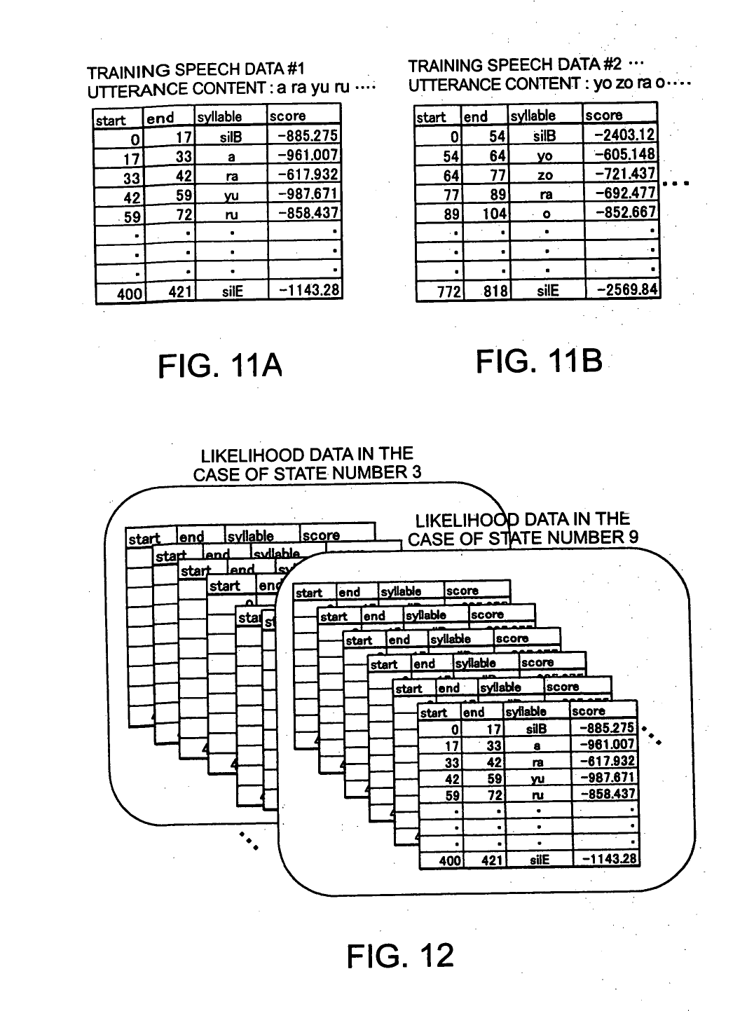

For example, FIG. 11A shows a result when the likelihood is calculated frame by frame (from the start frame to the end frame) for the speech training data #1, such as “a ra yu ru (all). . . ”, for individual syllable HMM's in all the syllable HMM's belonging to the syllable HMM set 31 having the state number 3. Referring to FIGS. 11 A-B, “score” stands for the likelihood for each syllable.

Likewise, FIG. 11B shows a result when the likelihood is calculated frame by frame (from the start frame to the end frame) for the speech training data #2, such as “yo zo ra o (night sky). . . ”, for individual syllable HMM's in all the syllable HMM's belonging to the syllable HMM set 31 having the state number 3.

The likelihoods are calculated as above for syllable HMM's having all the state numbers (herein, the state number 3 through the state number 9), using the speech training data #1, #2, and so on that have been prepared.

FIG. 12 shows a result of likelihood calculation obtained by calculating likelihoods for the syllable HMM sets 31 through 37 having the state number 3 through the state number 9, respectively, using respective syllable HMM's and the speech training data #1, #2, and so on that have been prepared.

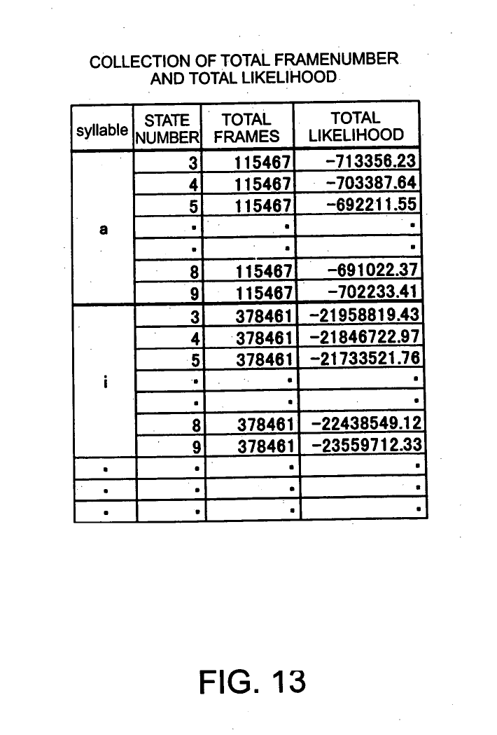

Then, as shown in FIG. 13, a total number of frames and a total likelihood for each of the state numbers from the state number 3 to the state number 9 are found for 124 syllables /a/, /i/, and so on, using the likelihood calculation results as are shown in FIG. 12 and the data indicating the start frame numbers and the end frame numbers as are shown in FIG. 10.

In this case, a total number of frames in a data interval matched to a given syllable is equal in each state (the state number 3 through the state number 9), because the start frames and the end frames matched to respective syllables are fixed for respective training speech data, regardless of the state number of the syllable HMM's. For example, referring to FIG. 13, a total number of frames of a syllable /a/ in this case is “115467” in each of the state number 3 through the state number 9, and a total number of frames of a syllable /i/ in this case is “378461” in each of the state number 3 through the state number 9.

Also, referring to FIG. 13, a total likelihood of a syllable /a/ is a maximum in the case of the state number 8, and a total likelihood of a syllable /i/ is a maximum in the case of the state number 5 in FIG. 13. FIG. 13 shows only a syllable /a/ and a syllable /i/; however, a total number of frames and a total likelihood are found in each state for all the syllables.

When a total number of frames and a total likelihood are found in each state for all the syllables as has been described, the description length is computed using the results of FIG. 13 and Equation (2) above. In other words, in Equation (2) above to find the description length li(χ^{N}), the first term on the right side is equivalent to a total likelihood, and N in the second term on the right side is equivalent to a total number of frames. Hence, a total likelihood in FIG. 13 is substituted in the first term on the right side, and a total number of frames in FIG. 13 is substituted for N in the second term on the right side. For example, when the foregoing is considered using a syllable /a/, as can be understood from FIG. 13, a total number of frames is “115467” and a total likelihood is “−713356.23” in the case of the state number 3, and these values are substituted in the right side of Equation (2) above.

Herein, a value of β is a dimension number of a model, and in this example experiment, 16 is given as the distribution number, 25 is given as the dimension number of the feature vector (cepstrum is 12 dimensions, delta cepstrum is 12 dimensions, and delta power is 1 dimension). Hence, β=1200 in the case of the state number 3, p=1600 in the case of the state number 4, and β=2000 in the case of the state number 5. Herein, 1.0 is given as the weighting coefficient α.

Hence, the description length of a syllable /a/ when syllable HMM's having the state number 3 are used (indicated as L(3, a)) is found as follows: L(3, a)=713356.23+1.0×(1200/2)×log(115467)=716393.7047 . . . (4). Because a total likelihood is found as a negative value (see FIG. 13) and a negative sign is appended to the first term on the right side of Equation (2) above, a total likelihood is expressed as a positive value.

Likewise, for the state number 4, the state number 5, . . . , the state number 8, and the state number 9 shown in FIG. 13, the description length of a syllable /a/ when syllable HMM's having the state number 4 are used (indicated as L(4, a)), the description length of a syllable /a/ when syllable HMM's having the state number 5 are used (indicated as L(5, a)), the description length of a syllable /a/ when syllable HMM's having the state number 8 are used (indicated as L(8, a)), and the description length of a syllable /a/ when syllable HMM's having the state number 9 are used (indicated as L(9, a)) are found as follows:
L(4, a)=703387.64+1.0×(1600/2)×log(115467)=707437.6063 (5)
L(5, a)=698211.55+1.0×(2000/2)×log(115467)=703274.0078 (6)
L(8, a)=691022.37+1.0×(3200/2)×log(115467)=699122.3026 (7)
L(9, a)=702233.41+1.0×(3600/2)×log(115467)=711345.8341 (8)

The state number 6 and the state number 7 are omitted from the example described above. The description lengths are found for the state number 6 and the state number 7 in the same manner. In this manner, the foregoing calculation is performed for all the syllables. The minimum description length is searched through the description lengths found as described above in each state number (herein, the state number 3 through the state number 9) for all the syllables (for example, 124 syllables).

For example, in the case of the state number 3 as described above, when the minimum description length is searched through the description lengths found from Equation (4) through Equation (8) above, it is understood that, in this experiment, the description length is a minimum when a syllable HMM having the state number 8 is used. Although the description lengths for the state number 6 and the state number 7 are not shown, these description lengths are assumed to have larger values than that of the description length when a syllable HMM having the state number 8 is used.

It is therefore understood that, for a syllable /a/, the minimum description length can be obtained when a syllable HMM having the state number 8 is used.

By performing the foregoing processing for all the syllables, it is possible to find an optimum state number for each syllable. This enables the state numbers of syllable HMM's of respective syllables to be optimized. By re-training the syllable HMM's having the state numbers optimized in this manner, it is possible to obtain a syllable HMM set having the optimized state numbers.

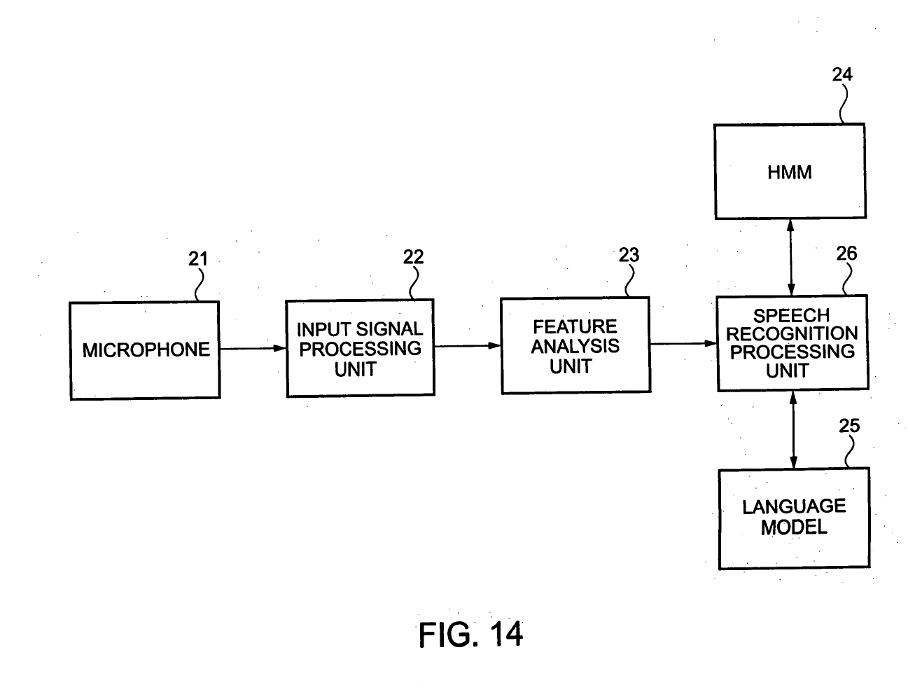

FIG. 14 is a schematic view showing the configuration of a speech recognition apparatus using acoustic models (HMM's) created as has been described, which includes a microphone 21 used to input a speech, an input signal processing unit 22 to amplify a speech inputted from the microphone 21 and to convert the speech into a digital signal; a feature analysis unit 23 to extract feature data (feature vector) from a speech signal, converted into a digital form, from the input signal processing unit; and a speech recognition processing unit 26 to recognize the speech with respect to the feature data outputted from the feature analysis unit 23, using an HMM 24 and a language model 25. As the HMM 24, HMM's (the syllable HMM set 10 having the optimized state numbers as is shown in FIG. 1) created by the acoustic model creating method described above are used.

As has been described, because the respective syllable HMM's (syllable HMM's of respective 124 syllables) are acoustic models having state numbers optimized for each syllable HMM in the speech recognition apparatus, it is possible to reduce the number of parameters in respective syllable HMM's markedly while maintaining high recognition ability. Hence, a volume of computation and a quantity of used memories can be reduced, and the processing speed can be increased. Moreover, because the prices and the power consumption can be lowered, the speech recognition apparatus is extremely useful as the one to be installed in a compact, inexpensive system whose hardware resource is strictly limited.

Incidentally, a recognition experiment of a sentence in 124 syllable HMM's was performed as a recognition experiment using the speech recognition apparatus of exemplary embodiments of the invention that uses the syllable HMM set 10 having optimized state number for each state. Then, when the state numbers were equal (when the state numbers were not optimized), the recognition rate was 79.84%, and the recognition rate was increased to 81.23% when the state numbers were optimized by the invention, from which enhancements of the recognition rate can be confirmed. Comparison in terms of recognition accuracy reveals that when the state numbers were equal (when the state numbers were not optimized), the recognition accuracy was 69.41%, and the recognition accuracy was increased to 77.7% when the state numbers were optimized by the invention, from which significant enhancement of the recognition accuracy can be confirmed.

The recognition rate and the recognition accuracy will now be described briefly. The recognition rate is also referred to as a correct answer rate, and the recognition accuracy is also referred to as correct answer accuracy. Herein, the correct answer rate (word correct) and the correct answer accuracy (word accuracy) for a word will be described. Generally, the word correct is expressed by: (total word number N−drop error number D−substitution error number S)/total word number N. Also, the word accuracy is expressed by: (total word number N−drop error number D−substitution error number S−insertion error number I)/total word number N.

The drop error occurs, for example, when the recognition result of an utterance example, “RINGO/2/KO/KUDASAI (please give me two apples)”, is “RINGO/O/KUDASAI (please give me an apple)”. Herein, the recognition result, from which “2” is dropped, has one drop error. Also, “KO” is substituted by “0”, and “0” is a substitution error.

When the recognition result of the same utterance example is “MIKAN/5/KO/NISHITE/KUDASAI (please give me five oranges, instead)”, because “RINGO” is substituted by “MIKAN” and “2” is substituted by “5” in the recognition result, “MIKAN” and “2” are substitution errors. Also, because “NISHITE” is inserted, “NISHITE” is an insertion error.

Then number of drop errors, the number of substation errors, and the number of insertion errors are counted in this manner, and the word correct and the word accuracy can be found by substituting these numbers into equations specified above.

### Second Exemplary Embodiment

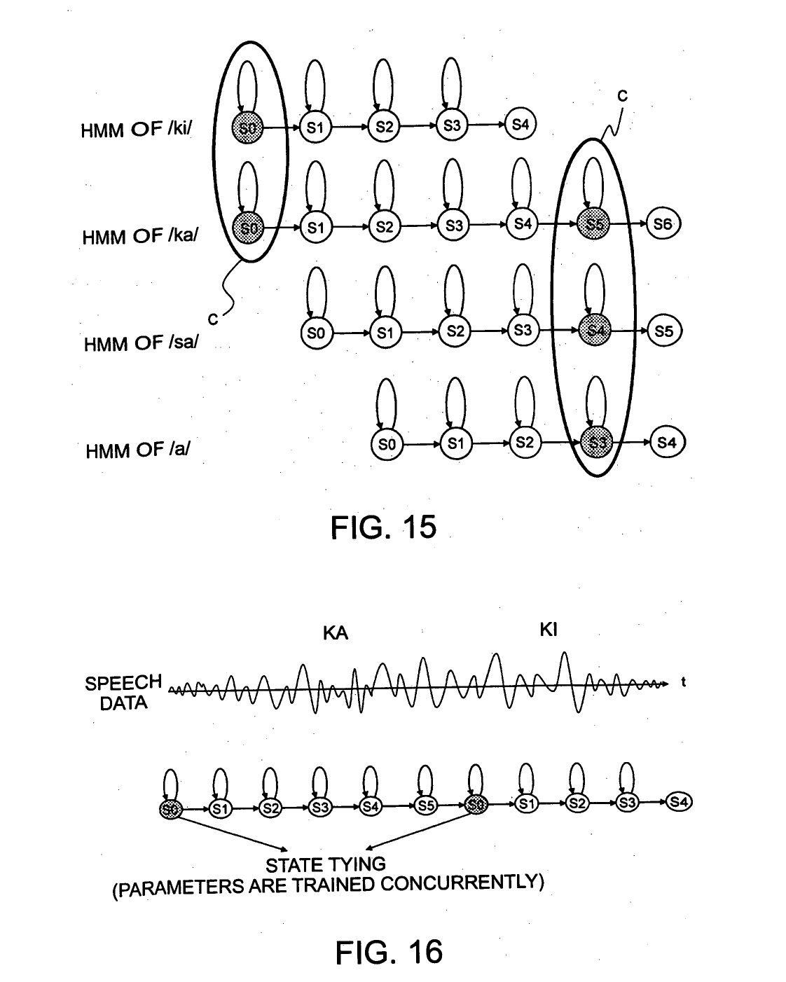

A second exemplary embodiment is to construct, in syllable HMM's having the same consonant or the same vowel, syllable HMM's that tie initial states or final states among plural states (states having self loops) forming these syllable HMM's. The state tying is performed after the processing described in the first exemplary embodiment, that is, the processing to optimize each state number of respective syllable HMM's. The description will be given with reference to FIG. 15.

Herein, consideration is given to syllable HMM's having the same consonant or the same vowel, for example, syllable HMM's of a syllable /ki/, syllable HMM's of a syllable /ka/, syllable HMM's of a syllable is /a/, and syllable HMM's of a syllable /a/ are concerned. To be more specific, a syllable /ki/ and a syllable /ka/ both have a consonant /k/, and a syllable /ka/, a syllable is /sa/, and a syllable /a/ all have a vowel /a/. In this case, assume that, as the result of optimization of the state numbers, a syllable HMM of a syllable /ki/ has the state number 4, a syllable HMM of a syllable /ka/ has the state number 6, a syllable HMM of a syllable /sa/ has the state number 5, and a syllable HMM of a syllable /a/ has the state number 4 (all of which are state numbers having self loops).

For syllable HMM's having the same consonant, states present in the preceding stage (herein, first states) in respective syllable HMM's are tied. For syllable HMM's having the same vowel, states present in the subsequent stage (herein, final states in the states having self loops) in respective syllable HMM's are tied.

FIG. 15 is a schematic view showing that the first state S0 in a syllable HMM of a syllable /ki/ and the first state S0 in a syllable HMM of a syllable /ka/ are tied, and the final state S5 in a syllable HMM of a syllable /ka/, the final state S4, having a self loop, in a syllable HMM of a syllable /sa/, and the final state S3, having a self loop, in a syllable HMM of a syllable /a/ are tied. In either case, states being tied are enclosed in an elliptic frame C indicated by a thick solid line.

The states that are tied by state tying in syllable HMM's having the same consonant or the same vowel in this manner will have the same parameters, which are handled as the same parameters when HMM training (maximum likelihood estimation) is performed.

For example, as is shown in FIG. 16, when an HMM is constructed for speech data, “KAKI (persimmon)”, in which a syllable HMM of a syllable /ka/ comprising six states, S0, S1, S2, S3, S4, and S5, each having a self loop, is connected to a syllable HMM of a syllable /ki/ comprising four states, S0, S1, S2, and S3, each also having a self loop, the first state S0 in the syllable HMM of the syllable /ka/ and the first state S0 in the syllable HMM of the syllable /ki/ are tied. The state S0 in the syllable HMM of the syllable /ka/ and the state S0 in the syllable HMM of the syllable /ki/ are then handled as those having the same parameters, and thereby trained concurrently.

When states are tied as described above, the number of parameters is reduced, which can in turn reduce a quantity of used memories and a volume of computation. Hence, not only operations on a low processing-power CPU are enabled, but also power consumption can be lowered, which allows applications to a system for which lower prices are required. In addition, in a syllable having a smaller volume of training speech data, it is expected that an advantage of preventing deterioration of recognition ability due to over-training can be addressed and/or achieved by reducing the number of parameters.

When states are tied as described above, for a syllable HMM of the syllable /ki/ and a syllable HMM of the syllable /ka/ taken as an example herein, an HMM is constructed in which the respective first states S0 are tied. Also, for a syllable HMM of the syllable /ka/, a syllable HMM of the syllable is /sa/, and a syllable HMM of the syllable /a/, an HMM is constructed in which the final states (in the case of FIG. 15, the state S5 in the syllable HMM of the syllable /ka/, the state S4 in the syllable HMM of the syllable is /a/, and the state S3 in the syllable HMM of the syllable /a/) are tied.

Hence, by creating syllable HMM's, in which the state numbers are optimized and states are tied as has been described, and by applying such syllable HMM's to the speech recognition apparatus as shown in FIG. 14, it is possible to further reduce the number of parameters in respective syllable HMM's while maintaining high recognition ability. A volume of computation and a quantity of used memories, therefore, can be reduced further, and the processing speed can be increased. Moreover, because the prices and the power consumption can be lowered, the speech recognition apparatus is extremely useful as the one to be installed in a compact, inexpensive system whose hardware resource is strictly limited due to a need for a cost reduction.

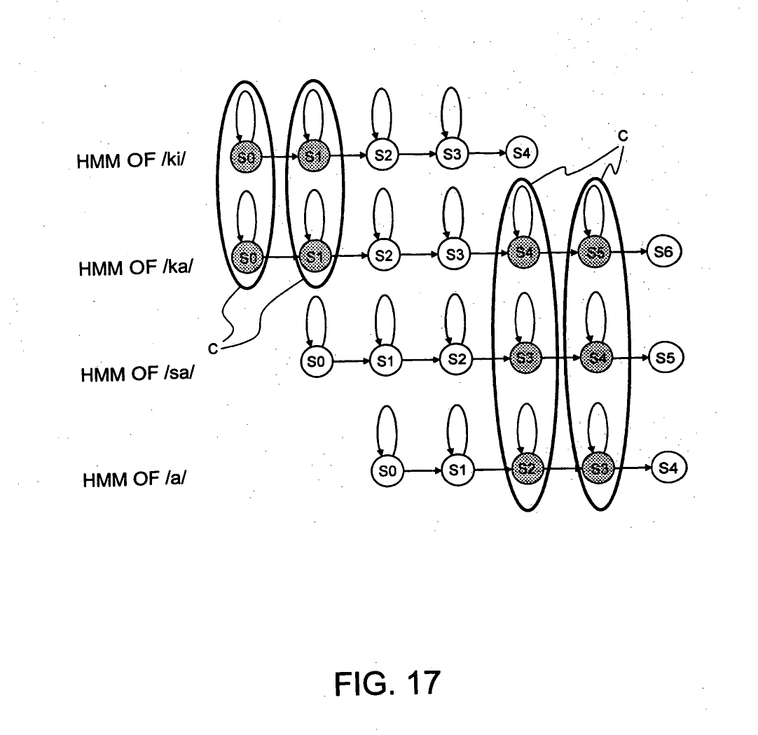

While an example of state tying has been described in a case where the initial states and the final states are tied among plural states forming syllable HMM's in syllable HMM's having the same consonant or the same vowel, as is shown in FIG. 17, plural (two in FIG. 17) states including the initial states or plural states including the final states, may be tied. This enables the number of parameters to be reduced further.

It should be appreciated that exemplary embodiments of the invention are not limited to the exemplary embodiments above, and can be implemented in various exemplary modifications without deviating from the scope of the invention. For example, syllable HMM's were described in the first exemplary embodiment; however, exemplary embodiments of the invention are applicable to phoneme HMM's.

Also, in the first exemplary embodiment, the distribution number is fixed to a given value (the distribution number is 64 in the aforementioned case); however, it is possible to optimize the distribution number in each of the states forming respective syllable HMM's. For example, a given distribution number (distribution number 1) may be set first, and the state numbers are optimized through the processing as described in the exemplary embodiment above, after which optimum distribution numbers may be set by changing the distribution number to 2, 4, 8, 16, and so on. By optimizing the distribution number in each state while optimizing the state numbers in this manner, it is possible to enhance the recognition ability further.

According to exemplary embodiments of the invention, an acoustic model creating program written with an acoustic model creating procedure to address and/or achieve exemplary embodiments of the invention may be created, and recorded in a recoding medium, such as a floppy disc, an optical disc, and a hard disc. Exemplary embodiments of the invention, therefore, include a recording medium having recorded the acoustic model creating program. Alternatively, the acoustic model creating program may be obtained via a network.

1. An acoustic model creating method of optimizing state numbers of HMM's (Hidden Markov Models) and re-training HMM's having the optimized state numbers with the use of training speech data, the acoustic model creating method comprising:
setting the state numbers of HMM's to plural kinds of state numbers from a given value to a maximum state number, and finding a description length of each of the HMM's that are set to have the plural kinds of state numbers, with the use of a Minimum Description Length criterion;
selecting an HMM having the state number with which the description length is a minimum; and
re-training the selected HMM with the use of training speech data.

2. The acoustic model creating method according to claim 1,
according to said Minimum Description Length criterion, when a model set {1, . . . , i, . . . , I} and data χ^{N}={χ₁, . . . , χ_{N}} (where N is a data length) are given, a description length li(χ^{N}) using a model i being expressed by a general equation:
$${l}_{i} ( {x}^{N} ) = - log {P}_{\hat{θ} ( i )} ( {x}^{N} ) + \frac{{β}_{i}}{2} log N + log I \qquad ( 1 )$$
where \hat{θ}(i) is a parameter of the model i, θ⁽ⁱ⁾=θ₁⁽¹⁾, . . . , θ_{β}_{ᵢ}⁽ⁱ⁾ is a quantity of maximum likelihood estimation, and βᵢ is the dimension of the model i; and
in the general equation to find the description length, the model set {1, . . . , i, I} being a set of HMM's when the state number of an HMM is set to plural kinds from a given value to a maximum state number, then, given I kinds (I is an integer satisfying I≧2) as the number of the kinds of states, 1, . . . , i, . . . , I are codes to specify respective kinds from a first kind to an I'th kind, and the Equation (1) is used as an equation to find a description length of an HMM having an i'th state number among 1, . . . , i, . . . , I.

3. The acoustic model creating method according to claim 1, an equation in a re-written form of the Equation (1) expressed as follows is used as an equation to find said description length:
$${l}_{i} ( {x}^{N} ) = - log {P}_{\hat{θ} ( i )} ( {x}^{N} ) + α ( \frac{{β}_{i}}{2} log N ) \vert$$
where \hat{θ}(i) is a parameter of the model i and θ⁽ⁱ⁾=θ₁⁽ⁱ⁾, . . . , θ_{β}_{ᵢ}⁽ⁱ⁾ is a quantity of maximum likelihood estimation.

4. The acoustic model creating method according to claim 3,
α in the Equation (2) being a weighting coefficient to obtain an optimum state number.

5. The acoustic model creating method according to claim 3:
β in the Equation (2) being expressed by: distribution number×dimension number of feature vector×state number.

6. The acoustic model creating method according to claim 2:
the data χ^{N} being a set of respective training speech data obtained by matching, for each state in time series, HMM's having an arbitrary state number among the given value through the maximum state number to a large number of training speech data.

7. The acoustic model creating method according to claim 1:
the HMM's being syllable HMM's.

8. The acoustic model creating method according to claim 7,
for plural syllable HMM's having a same consonant or a same vowel among the syllable HMM's, of states forming the syllable HMM's, initial states or plural states including the initial states in syllable HMM's being tied for syllable HMM's having the same consonant, and final states among states having self loops or plural states including the final states in syllable HMM's being tied for syllable HMM's having the same vowels.

9. An acoustic model creating apparatus that optimizes state numbers of HMM's (Hidden Markov Models) and re-trains HMM's having the optimized state numbers with the use of training speech data, the acoustic model creating apparatus comprising:
a description length calculating device to find a description length of each of HMM's when the state number of an HMM is set to plural kinds of state numbers from a given value to a maximum state number, with the use of a Minimum Description Length criterion;
an HMM selecting device to select an HMM having the state number with which the description length found by the description length calculating device is a minimum; and
an HMM re-training device to re-train the HMM selected by the HMM selecting device with the use of training speech data.

10. An acoustic model creating program for use with a computer to optimize state numbers of HMM's (Hidden Markov Models) and re-train HMM's having the optimized state numbers with the use of training speech data, the acoustic model creating program comprising:
a program for finding a description length of each of HMM's when the state number of an HMM is set to plural kinds of state numbers from a given value to a maximum state number, with the use of a Minimum Description Length criterion;
a program for selecting an HMM having the state number with which the description length is a minimum; and
a program for re-training the selected HMM with the use of training speech data.

11. A speech recognition apparatus to recognize an input speech, using HMM's (Hidden Markov Models) as acoustic models with respect to feature data obtained through feature analysis on the input speech, the speech recognition apparatus comprising:
HMM's created by the acoustic model creating method according to claim 1 are used as the HMM's used as the acoustic models.
